(19) United States
(12) Patent Application Publication
(10) Pub. No.: US 2025/0233361 A1
(43) Pub. Date: Jul. 17, 2025

(54) ELECTRICAL CONNECTOR HAVING A MATED VERFICIATION SWITCH

(71) Applicant: TE Connectivity Solutions GmbH, Schaffhausen (CH)

(72) Inventors: Galen M. Martin, Mechanicsburg, PA (US); Romit Sakar, Kernersville, NC (US); Xiaobao Geng, Troy, MI (US)

(21) Appl. No.: 18/742,877

(22) Filed: Jun. 13, 2024

Related U.S. Application Data
(60) Provisional application No. 63/641,567, filed on May 2, 2024.

(30) Foreign Application Priority Data
Jan. 12, 2024 (IN) 202441002377

(51) Int. Cl. H01R 13/641; H01R 13/627; H01R 13/703

(52) U.S. Cl. CPC H01R 13/641; H01R 13/6272; H01R 13/7033

(57) ABSTRACT

An electrical connector includes a housing holding contacts and having a securing element configured to be latchably coupled to a mating securing element of a mating electrical connector when the housing is fully mated to the mating electrical connector. The electrical connector includes a mated verification switch coupled to the housing having a first verification contact and a second verification contact both coupled to the housing. The second verification contact is configured to be physically separated from the first verification contact prior to the housing being fully mated to the mating electrical connector but is configured to engage the first verification contact when the housing is fully mated to the mating electrical connector to send a verification signal through the mated verification switch indicative of the electrical connector being mated with the mating electrical connector.

### CROSS REFERENCE TO RELATED APPLICATIONS

This application claims benefit to IN Application No. 202441002377, filed 12 Jan. 2024, titled “ELECTRICAL CONNECTOR POSITION ASSURANCE WITH A SPRING ON THE DEVICE”, and U.S. Application No. 63/641,567, filed 2 May 2024, titled “ELECTRICAL CONNECTOR HAVING A MATED VERIFICATION SWITCH” the subject matter of which are herein incorporated by reference in their entirety.

### BACKGROUND OF THE INVENTION

The subject matter herein relates generally to electrical connectors.

Communication systems include electrical connectors, which are mated to electrically connect various components of the system. For example, a header connector may be mounted to a device, such as to a circuit board, for mating with a plug connector, which may be terminated to a wire harness or another circuit board. The electrical connectors typically include latches to secure the electrical connectors together, once mated. However, when improperly mated, the latches may separate allowing the electrical connectors to become inadvertently unmated over time. To avoid such situation, some electrical connectors include connector position assurance (CPA) devices that are used to ensure proper latching of the electrical connectors. The CPA devices are typically mechanical devices that are mechanically actuated during assembly providing visual and/or tactile feedback to the installer. However, the installer may improperly verify actuation of the CPA devices.

Some known electrical connectors use electrically activated connector verification systems that verifies proper connection using electrical signals passing through a verification circuit. For example, the electrical connectors may include last-mate contacts in the plug connector and the header connector that are mated after the plug connector and the header connector are fully mated creating a verification circuit when the plug connector and the header connector are fully mated. Such systems increase overall cost of the communication system by redesigning both electrical connectors to include the additional contacts.

A need remains for a cost effective and reliable mating verification system for electrical connectors.

### BRIEF DESCRIPTION OF THE INVENTION

In one embodiment, an electrical connector is provided and includes a housing having walls that extends between a mating end and a terminating end. The mating end is configured to be mated to a mating electrical connector. The electrical connector includes contacts held by the housing. Each contact extends between a mating end and a terminating end. The mating end of the contact is configured to be mated to a mating contact of the mating electrical connector. The electrical connector includes a securing element configured to be latchably coupled to a mating securing element of the mating electrical connector when the housing is fully mated to the mating electrical connector. The electrical connector includes a mated verification switch coupled to the housing. The mated verification switch includes a first verification contact and a second verification contact both coupled to the housing. The second verification contact is configured to be physically separated from the first verification contact prior to the housing being fully mated to the mating electrical connector. The second verification contact is configured to engage the first verification contact when the housing is fully mated to the mating electrical connector to send a verification signal through the mated verification switch indicative of the electrical connector being mated with the mating electrical connector.

In another embodiment, an electrical connector is provided and includes a housing having walls that form a cavity. The housing extends between a mating end and a terminating end. The mating end is configured to be mated to a mating electrical connector. The terminating end is configured to be mounted to a host circuit board. The electrical connector includes contacts held by the housing. Each contact extends between a mating end and a terminating end. The mating end of the contact is configured to be mated to a mating contact of the mating electrical connector. The terminating end of the contact is configured to be terminated to the host circuit board. The electrical connector includes a securing element configured to be latchably coupled to a mating securing element of the mating electrical connector when the housing is fully mated to the mating electrical connector. The electrical connector includes a mated verification switch coupled to the housing. The mated verification switch includes a first verification contact and a second verification contact both coupled to the housing. The second verification contact movable between an open position and a closed position. The second verification contact is configured to be physically separated from the first verification contact in the open position. The second verification contact is configured to engage the first verification contact in the closed position to send a verification signal through the mated verification switch indicative of the electrical connector being mated with the mating electrical connector. The second verification contact is configured to interface with the mating securing element of the mating electrical connector when the mating securing element is securely coupled to the securing element to engage the first verification contact.

In a further embodiment, a communication system is provided and includes a plug connector that includes a plug housing, plug contacts held by the plug housing, and a plug latch having a securing element. The communication system includes a header connector that includes a header housing extending between a mating end and a terminating end. The terminating end is configured to be coupled to a host circuit board. The header housing includes a cavity configured to receive the plug connector. The header connector includes header contacts held by the header housing. Each header contact extends between a mating end and a terminating end. The mating end of the header contact is configured to be mated to the corresponding plug contact. The terminating end of the header contact is configured to be terminated to the host circuit board. The header connector includes a header latch having a securing element configured to be latchably coupled to the securing element of the plug latch when the plug housing is fully mated to the header housing. The communication system includes a mated verification switch coupled to the header housing. The mated verification switch includes a first verification contact and a second verification contact both coupled to the header housing. The second verification contact movable between an open position and a closed position, wherein the second verification is moved to the closed position by interference with the plug connector when the plug connector is mated to the header connector. The second verification contact is configured to be physically separated from the first verification contact in the open position. The second verification contact is configured to engage the first verification contact in the closed position to send a verification signal through the mated verification switch indicative of the plug connector being mated with the header connector.

### BRIEF DESCRIPTION OF THE DRAWINGS

FIG. 1 is a perspective view of a communication system in accordance with an exemplary embodiment.

FIG. 2 is a front perspective view of the header connector in accordance with an exemplary embodiment.

FIG. 3 is a side view of the header connector in accordance with an exemplary embodiment.

FIG. 4 is a perspective view of the mated verification switch in accordance with an exemplary embodiment.

FIG. 5 is a perspective view of a portion of the header connector showing the mated verification switch coupled to the header housing in accordance with an exemplary embodiment.

FIG. 6 is a front perspective view of the plug connector in accordance with an exemplary embodiment.

FIG. 7 illustrates one of the plug contacts in accordance with an exemplary embodiment.

FIG. 8 is a sectional view of a portion of the communication system showing the plug connector mated with the header connector in accordance with an exemplary embodiment.

FIG. 9 is a cross sectional view of a portion of the communication system in accordance with an exemplary embodiment.

FIG. 10 is a cross sectional view of a portion of the communication system showing the mated verification switch in an open position in accordance with an exemplary embodiment.

FIG. 11 is a cross sectional view of a portion of the communication system showing the mated verification switch in a closed position in accordance with an exemplary embodiment.

### DETAILED DESCRIPTION OF THE INVENTION

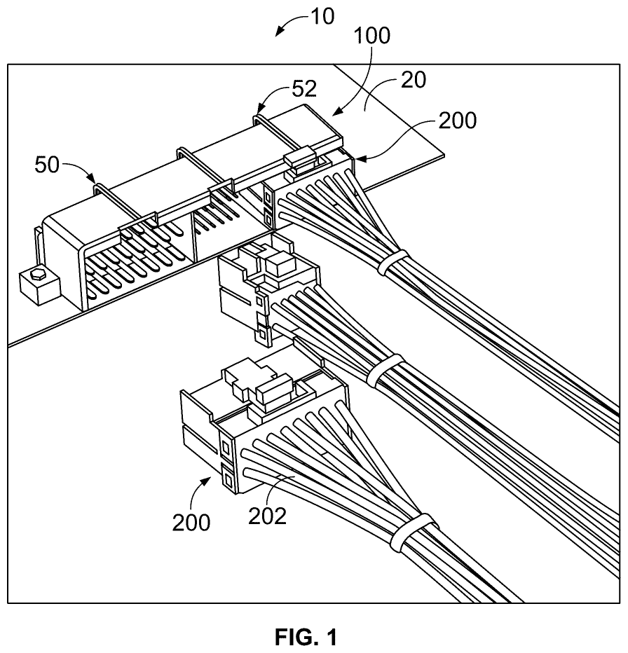

FIG. 1 is a perspective view of a communication system 10 in accordance with an exemplary embodiment. The communication system 10 includes a first electrical connector 100 and a second electrical connector 200 configured to be mated with the first electrical connector 100. The communication system 10 may include a plurality of the electrical connectors 100 and/or a plurality of the electrical connectors 200. In the illustrated embodiment, a plurality of the electrical connectors 200 configured to be mated with a single electrical connector 100. The electrical connectors 200 are mating electrical connectors for the first electrical connector 100. Similarly, the first electrical connector 100 is considered a mating electrical connector for the second electrical connectors 200.

In an exemplary embodiment, the first electrical connector 100 is a header connector and may be referred to hereinafter as header connector 100. The header connector 100 is mounted to a component, such as a host circuit board 20. However, the component may be a non-electrical component in alternative embodiments, such as a panel or wall of the device used to hold the header connector 100. In an exemplary embodiment, the header connector 100 is a board mounted connector mounted to and electrically connected to the host circuit board 20. In the illustrated embodiment, the header connector 100 is a right angle connector having the mounting end oriented perpendicular to the mated end. Other orientations are possible in alternative embodiments, such as a straight pass-through connector, such as a vertical connector. In other various embodiments, the header connector 100 is a cable connector provided at an end of one or more cables.

In an exemplary embodiment, the second electrical connector 200 is a plug connector and may be referred to hereinafter as plug connector 200. The plug connector 200 is configured to be plugged into a receptacle or socket of the header connector 100. In an exemplary embodiment, the plug connector 200 is a cable connector provided at an end of one or more cables 202. In the illustrated embodiment, the cables 202 extend from an end opposite the mating end of the plug connector 200. In other various embodiments, the plug connector 200 may be a right angle connector having the cables 202 extend perpendicular to the mating end. In other various embodiments, the plug connector 200 may be a board mounted connector configured to be mounted to a circuit board.

In an exemplary embodiment, the communication system 10 includes a mated verification system 50 that provides electrical signals to provide mating assurance of the electrical connectors 100, 200. For example, the mated verification system 50 provides a verification signal to the communication system 10 when the electrical connectors 100, 200 are fully mated or when the electrical connectors 100, 200 become unmated. For example, when the electrical connectors 100, 200 are unmated, the mated verification system 50 has an open circuit (or a closed circuit depending on the arrangement of the circuit components). When the electrical connectors 100, 200 are fully mated, the mated verification system 50 has a closed circuit that transmits the verification signal. The electrical connectors 100, 200 are fully mated when all contacts of the electrical connectors 100, 200 are mated and the latching components of the electrical connectors 100, 200 are latched. Prior to latching of the latching components, even if the contacts of the electrical connectors 100, 200 are mated, the electrical connectors 100, 200 are considered unmated. As such, the mated verification system 50 forms a connector position assurance (CPA) device for the communication system 10.

In an exemplary embodiment, the mated verification system 50 includes a mated verification switch 52 configured to be opened and closed based on the relative positions of the electrical connectors 100, 200. In an exemplary embodiment, the mated verification switch 52 is normally open. The mated verification switch 52 is configured to be closed when the electrical connectors 100, 200 are fully mated. Alternatively, the mated verification switch 52 is normally closed and configured to be opened when the electrical connectors 100, 200 are fully mated. In an exemplary embodiment, the components of the mated verification switch 52 form part of the header connector 100. For example, no components of the mated verification switch 52 are part of the plug connector 200. However, in alternative embodiments, all of the components of the mated verification switch 52 may be part of the plug connector 200 and none of the components of the mated verification switch 52 may be part of the header connector 100. Providing all of the components on either the header connector 100 or the plug connector 200 eliminates the need to redesign both electrical connectors 100, 200, thus reducing the overall manufacturing costs for the communication system 10. Providing all of the components on either the header connector 100 or the plug connector 200 reduces the complexity of the system. Providing all of the components on either the header connector 100 plug connector 200 eliminates the need to meet the components at the mating interface between the electrical connectors 100, 200, which would add complexity and tolerances to the mating interfaces. In an exemplary embodiment, the mated verification switch 52 is configured to interface with the mating electrical connector for actuation of the mated verification switch 52. For example, when the mated verification switch 52 is part of the header connector 100, one or more of the components of the mated verification switch 52 interface with the plug connector 200 when the plug connector 200 is fully mated with the header connector 100 to actuate and close the mated verification switch 52 to transmit the verification signal only after the plug connector 200 is fully mated with the header connector 100.

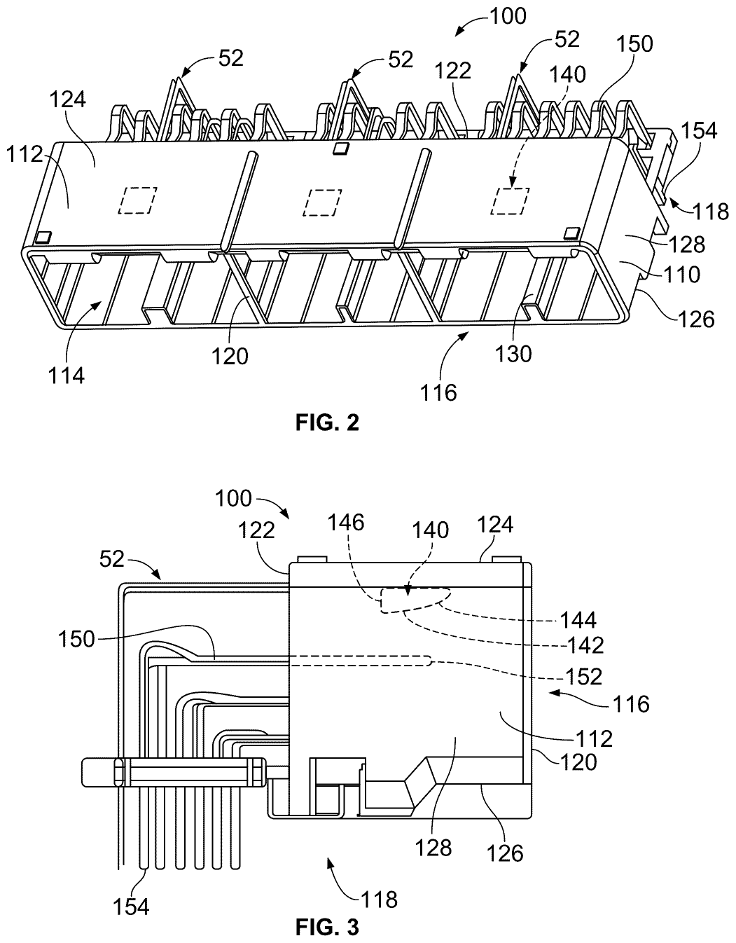

FIG. 2 is a front perspective view of the header connector 100 in accordance with an exemplary embodiment. FIG. 3 is a side view of the header connector 100 in accordance with an exemplary embodiment. In an exemplary embodiment, the header connector 100 includes the mated verification switch 52. In various embodiments, the header connector 100 may include multiple mated verification switches 52, such as for assuring mated connections with multiple plug connectors 200 (shown in FIG. 1).

The header connector 100 includes a header housing 110 holding a plurality of header contacts 150. The header connector 100 includes a header securing element 140 (shown in phantom) used to securely couple the plug connector 200 to the header connector 100. In an exemplary embodiment, the header securing element 140 is a latch and may be referred to hereinafter as a latch 140. The latch 140 includes a latching element 142, such as a catch surface. Other types of securing elements may be used in alternative embodiments other than a latch, such as a fastener, a clip, or another type of securing element.

In an exemplary embodiment, the header housing 110 is manufactured from a dielectric material. For example, the header housing 110 may be molded from a plastic material. The header housing 110 includes a plurality of walls 112 forming a cavity 114 that receives the plug connector 200. The header housing 110 extends between a mating end 116 and a terminating end 118. The plug connector 200 is configured to be coupled to the mating end 116. The cavity 114 is open at the mating end 116 to receive the plug connector 200. In an exemplary embodiment, the terminating end 118 is configured to be mounted to the host circuit board 20 (shown in FIG. 1). In alternative embodiments, the terminating end 118 is configured to be coupled to one or more cables.

The header housing 110 includes a front 120 and a rear 122. The header housing 110 includes a top 124 and a bottom 126. The header housing 110 includes sides 128 between the top 124 and the bottom 126. In an exemplary embodiment, the mating end 116 is provided at the front 120. Other locations are possible in alternative embodiments, such as the top 124. The cavity 114 is open at the front 120 to receive the plug connector 200. In the illustrated embodiment, the latch 140 is provided at the top 124. For example, the latch 140 is located along an interior surface of the top wall at the top 124 of the header housing 110. Other locations are possible in alternative embodiments. In an exemplary embodiment, the terminating end 118 is provided at the bottom 126. Other locations are possible in alternative embodiments, such as the rear 122. In an exemplary embodiment, the header housing 110 includes interior walls, such as divider walls, that divides the cavity 114 into different chambers each configured to receive a corresponding plug connector 200. The divider walls may extend between the top 124 and the bottom 126. In an exemplary embodiment, the header housing 110 includes guide features 130 to guide mating of the plug connector 200 into the cavity 114. The guide features 130 may define keying features for keyed mating with particular plug connectors 200.

The latch 140 extends from one of the walls 112 of the header housing 110, such as the top wall. Optionally, the latch 140 may be integral with the header housing 110, such as being co-molded with the header housing 110. In various embodiments, the latching feature 142 is a fixed latching feature having a ramp surface 144 and a catch surface 146. In alternative embodiments, the latching feature 142 may be a deflectable latch, such as a deflectable latch arm.

The header contacts 150 are coupled to the header housing 110. In an exemplary embodiment, the contacts 150 are coupled to one or more of the walls 112 of the header housing 110. For example, the contacts 150 may be coupled to the rear wall at the rear 122 of the header housing 110. In an exemplary embodiment, the contacts 150 are stamped and formed contacts. Each contact 150 extends between a mating end 152 and a terminating end 154. The mating end 152 is configured to be mated with the plug connector 200. The terminating end 154 is configured to be electrically coupled to the host circuit board 20. In an exemplary embodiment, the contact 150 is a right angle contact having the mating end 152 perpendicular to the terminating end 154. For example, the mating end 152 may extend horizontally and the terminating end 154 may extend vertically. Other orientations are possible in alternative embodiments. The mating end 152 extends through the rear wall into the cavity 114 for mating with the plug connector 200. Optionally, the contact 150 may include a pin at the mating end 152. In other embodiments, the contact 150 may include a socket or other type of mating end. The terminating end 154 extends through the bottom wall of the header housing 110 for connection to the host circuit board 20. The bottom wall may form a contact organizer sued to hold relative positions of the terminating ends 154 of the contacts 150. Optionally, the terminating end 154 may include a solder tail. In other embodiments, the contact 150 may include a compliant pin or other type of terminating end. The contacts 150 may be arranged in one or more rows and one or more columns. The contacts 150 may include signal contacts and/or ground contacts and/or power contacts.

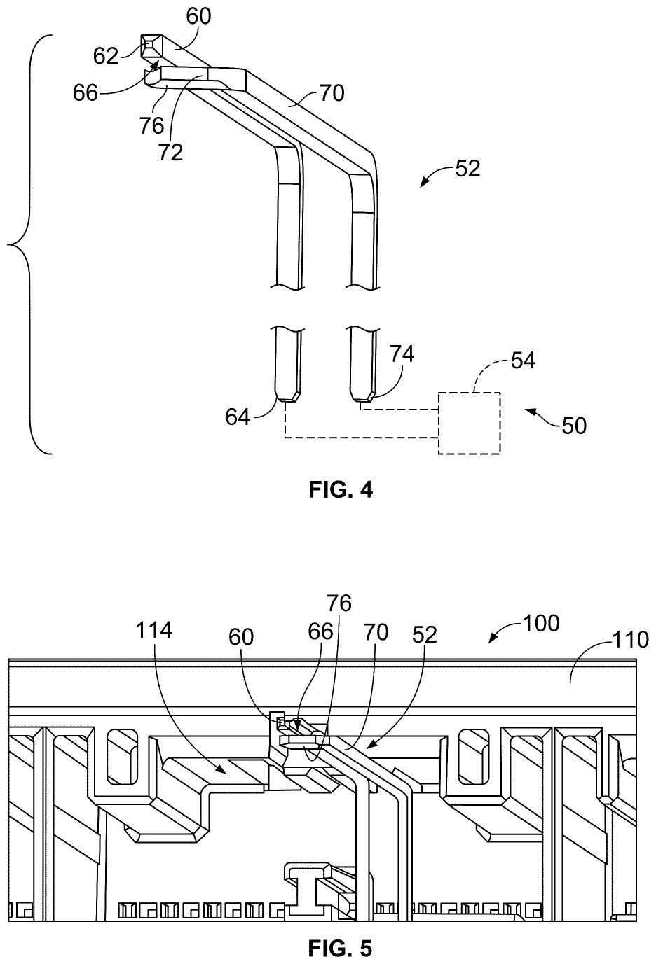

With additional reference to FIGS. 4 and 5, FIG. 4 is a perspective view of the mated verification switch 52 and FIG. 5 is a perspective view of a portion of the header connector 100 showing the mated verification switch 52 coupled to the header housing 110. The mated verification system 50 includes the mated verification switch 52. The mated verification switch 52 forms part of a mated verification circuit 54 that transmits electrical signals to the communication system 10 providing mating assurance of the electrical connectors 100, 200. For example, the mated verification system 50 provides a verification signal via the mated verification circuit 54 when the electrical connectors 100, 200 are fully mated or when the electrical connectors 100, 200 become unmated. The mated verification circuit 54 may be formed by one or more conductors of the host circuit board 20 and/or one or more electrical components on the host circuit board 20, such as a microprocessor configured to process the verification signal. The mated verification switch 52 is coupled to the header housing 110. For example, the mated verification switch 52 may be coupled to the rear wall and/or the top wall of the header housing 110.

In an exemplary embodiment, the mated verification switch 52 includes a first verification contact 60 and a second verification contact 70 both coupled to the header housing 110. The second verification contact 70 is configured to be physically separated from the first verification contact 60 prior to the electrical connectors 100, 200 being fully mated. For example, the mated verification circuit 54 is open when the verification contacts 60, 70 are physically separated or open. The second verification contact 70 is configured to engage the first verification contact 60 when the plug connector 200 is fully mated to the header connector 100, such as when the housings are fully mated and/or when the contacts are fully mated and/or when the latches are fully engaged. For example, the mated verification circuit 54 is closed when the verification contacts 60, 70 are physically connected. The mated verification circuit 54 sends the verification signal through the mated verification switch 52 indicative of the electrical connectors 100, 200 being mated. A visual or audible indicator may be provided when the verification signal is received indicating to the installer that the electrical connectors 100, 200 are fully mated. The mated verification circuit may operate in the opposite manner being normally closed and configured to be opened when the electrical connectors are fully mated.

In an exemplary embodiment, the first verification contact 60 is a stamped and formed contact. In other various embodiments, the first verification contact 60 may be a plated plastic conductor, such as being a plated portion of the header housing 110 forming a circuit. The first verification contact 60 extends between a mating end 62 and a terminating end 64. The mating end 62 is configured to be mated with the second verification contact 70 and/or the plug connector 200. In an exemplary embodiment, the first verification contact 60 includes a mating portion 66 at the mating end 62 configured to interface with the second verification contact 70. The terminating end 64 is configured to be electrically coupled to the host circuit board 20. In an exemplary embodiment, the first verification contact 60 is a right angle contact. The mating end 62 extends through the rear wall into the cavity 114. The terminating end 64 extends through the bottom wall of the header housing 110 for connection to the host circuit board 20.

In an exemplary embodiment, the second verification contact 70 is a stamped and formed contact. In other various embodiments, the second verification contact 70 may be a plated plastic conductor, such as being a plated portion of the header housing 110 forming a circuit. The second verification contact 70 extends between a mating end 72 and a terminating end 74. The mating end 72 is configured to be mated with the mating portion 66 of the first verification contact 60 and/or the plug connector 200. In an exemplary embodiment, the second verification contact 70 includes a connecting tab 76 at the mating end 72 configured to interface with the first verification contact 60. The terminating end 74 is configured to be electrically coupled to the host circuit board 20. In an exemplary embodiment, the second verification contact 70 is a right angle contact. The mating end 72 extends through the rear wall into the cavity 114. The terminating end 74 extends through the bottom wall of the header housing 110 for connection to the host circuit board 20.

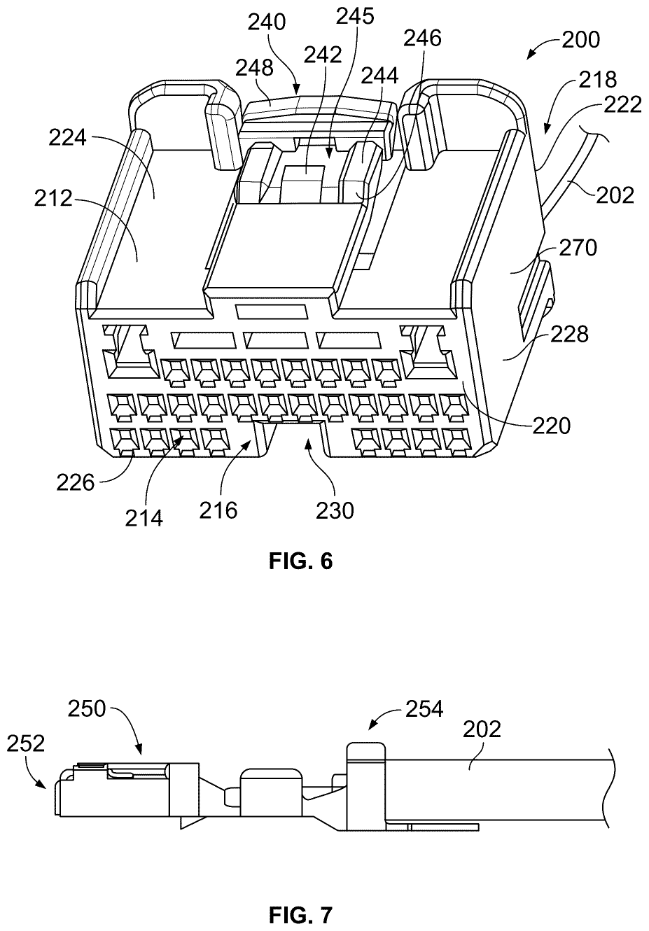

FIG. 6 is a front perspective view of the plug connector 200 in accordance with an exemplary embodiment. The plug connector 200 includes a plug housing 210 holding a plurality of plug contacts 250 (shown in FIG. 7). The plug connector 200 includes a plug securing element 240 used to securely couple the plug connector 200 to the header connector 100. In an exemplary embodiment, the header securing element 240 is a latch and may be referred to hereinafter as a latch 240. The latch 240 includes a latching element 242, such as a catch surface. Other types of securing elements may be used in alternative embodiments other than a latch, such as a fastener, a clip, or another type of securing element.

In an exemplary embodiment, the plug housing 210 is manufactured from a dielectric material. For example, the plug housing 210 may be molded from a plastic material. The plug housing 210 includes a plurality of walls 212. The plug housing 210 includes contact cavities 214 that receives the corresponding plug contacts 250. The plug housing 210 extends between a mating end 216 and a terminating end 218. The mating end 216 is configured to be plugged into the cavity 114 of the header housing 110 (shown in FIG. 2). In an exemplary embodiment, the terminating end 218 is a cable end with the cables 202 extending from the terminating end 218. In alternative embodiments, the terminating end 218 is configured to be mounted to a circuit board.

The plug housing 210 includes a front 220 and a rear 222. The plug housing 210 includes a top 224 and a bottom 226. The plug housing 210 includes sides 228 between the top 224 and the bottom 226. In an exemplary embodiment, the mating end 216 is provided at the front 220. Other locations are possible in alternative embodiments, such as the top 224. The contact cavities 214 are open at the front 220 to receive the header contacts 150. In an exemplary embodiment, the terminating end 218 is provided at the rear 222. However, the terminating end 218 may be at other locations, such as at the bottom 226. In the illustrated embodiment, the latch 240 is provided at the top 224. For example, the latch 240 is located along an exterior surface of the top wall at the top 224 of the plug housing 210. Other locations are possible in alternative embodiments. In an exemplary embodiment, the plug housing 210 includes guide features 230 to guide mating of the plug connector 200 with the header connector 100. The guide features 230 may define keying features for keyed mating with the header housing 110.

The latch 240 extends from one of the walls 212 of the plug housing 210, such as the top wall. Optionally, the latch 240 may be integral with the plug housing 210, such as being co-molded with the plug housing 210. In various embodiments, the latching feature 242 includes a deflectable latching arm 244 having a latch opening 245 that receives the latching feature 142 of the header connector 100 to latchably couple the plug connector 200 to the header connector 100. In an exemplary embodiment, the latching arm 244 includes a ramp 246 configured to engage the header connector 100, such as to deflect the latching arm 244. In the illustrated embodiment, the latch 240 includes an actuator 248, such as a push tab, used to release the latch 240. In an exemplary embodiment, the latch 240 is configured to interface with the mated verification switch 52 (shown in FIG. 4) to activate the mated verification switch 52. For example, the latch 240 may press against the second verification contact 70 to move the second verification contact 70 into engagement with the first verification contact 60 to close the mated verification circuit 54. In an exemplary embodiment, the latch 240 is configured to only engage the mated verification switch 52 when the latch 240 is latchably coupled to the latch 140 of the header connector 100, such as when the latching element 142 is received in the latch opening 245.

With additional reference to FIG. 7, which illustrates one of the plug contacts 250 in accordance with an exemplary embodiment. In an exemplary embodiment, the contacts 250 are configured to be terminated to the cables 202, such as being crimped to the ends of the cables 202. The contacts 250 are configured to be received in the contact channels 214. Each plug contact 250 extends between a mating end 252 and a terminating end 254. The mating end 252 is configured to be mated with the corresponding header contact 150. In the illustrated embodiment, the mating end 252 includes a socket; however other types of contacts may be provided in alternative embodiments, such as a pin, blade, spring beam or other type of contact. The terminating end 254 is configured to be electrically coupled to the cable 202. For example, the terminating end 254 may include a crimp barrel configured to be crimped to the cable 202.

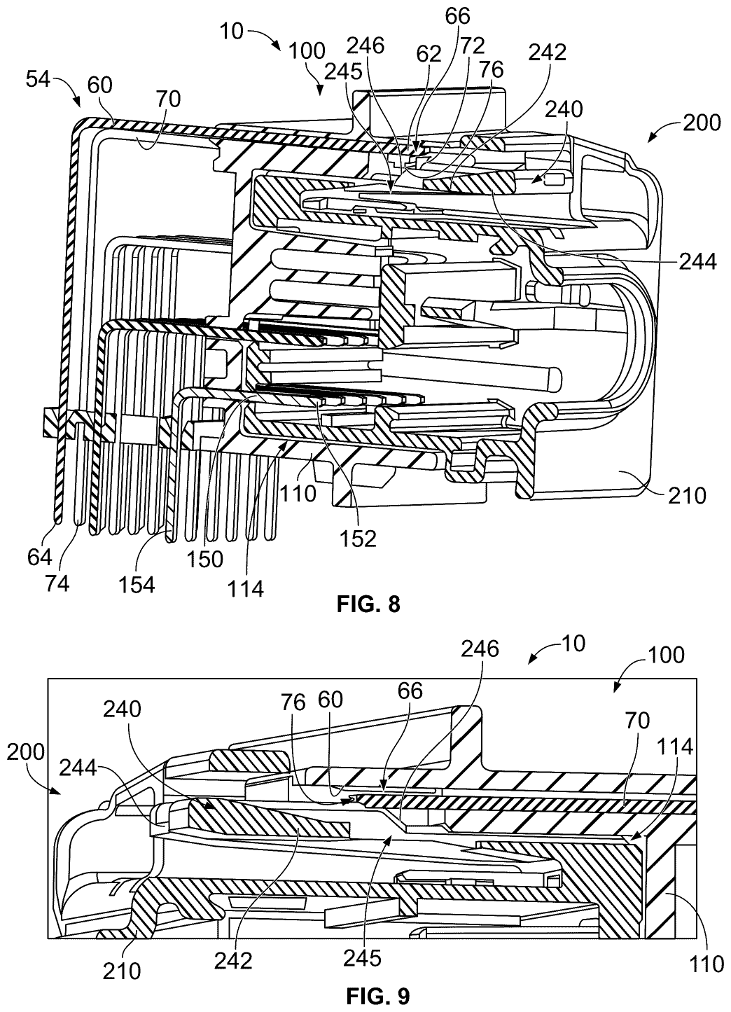

FIG. 8 is a sectional view of a portion of the communication system 10 showing the plug connector 200 mated with the header connector 100. FIG. 9 is a cross sectional view of a portion of the communication system 10. Portions of the plug connector 200 are removed to illustrate the interface with the header connector 100.

In an exemplary embodiment, the header contacts 150 are coupled to the rear wall and the bottom wall of the header housing 110. The mating ends 152 extend into the cavity 114 for mating with the plug connector 200. The terminating ends 154 extend through the contact organizer at the bottom wall for termination to the host circuit board 20. The contacts 150 may include signal contacts and/or ground contacts and/or power contacts.

In an exemplary embodiment, the first verification contact 60 and the second verification contact 70 are both coupled to the header housing 110. The terminating ends 64, 74 pass through the contact organizer of the bottom wall for termination to the host circuit board 20. The mating ends 62, 72 pass through the rear wall of the header housing 110 into the cavity 114, such as to interface with the plug connector 200 to verify mating of the plug connector 200 with the header connector 100. In the illustrated embodiment, the mating ends 62, 72 are located at the top of the cavity 114, such as along the top wall of the header housing 110. In an exemplary embodiment, the connecting tab 76 of the second verification contact 70 is configured to interface with the plug connector 200, such as the latch 240 of the plug connector 200. The latch 240 is used to press or move the connecting tab 76 to a closed position to physically engage the mating portion 66 of the first verification contact 60 to close the mated verification circuit 54 to send the verification signal indicative of the electrical connectors 100, 200 being fully mated and/or to send a signal when the electrical connectors 100, 200 become unmated. In an exemplary embodiment, the second verification contact 70 is configured to engage the first verification contact 60 only after the latching element 242 of the plug latch 240 is latchably coupled to the latching element 142 of the header latch 140.

During mating, the plug connector 200 is plugged into the cavity 114 of the header housing 110 and the plug latch 240 is latchably coupled to the header latch 140 to secure the plug connector 200 to the header connector 100. The latches 140, 240 are latchably coupled to each other when the plug connector 200 is fully mated with the header connector 100. Prior to full mating, the latches 140, 240 are unlatched. In an exemplary embodiment, the plug latch 240 is deflectable and movable between a deflected position and a released position. For example, the plug latch 240 may be pressed downward toward the top wall of the plug housing 210 to the deflected position during initial loading of the plug connector 200 into the cavity 114 of the header housing 110. For example, the ramp surface 144 of the header latch 140 may engage the latching arm 244 of the plug latch 240 to press the latching arm 244 downward. In the deflected position, the plug latch 240 does not actuate or close the mated verification switch. Once the latch opening 245 clears the latching element 142, the plug latch 240 is released and moved to a latched position latchably coupled to the header latch 140. When the latching arm 244 is released, the plug latch 240 is free to move upward to the released position (FIG. 9). In the released position, the plug latch 240 engages the second verification contact 70 to move the second verification contact 70 to the closed position. For example, the ramp 246 engages the connecting tab 76 to press the connecting tab 76 upward to the closed position to physically engage the mating portion 66 of the first verification contact 60.

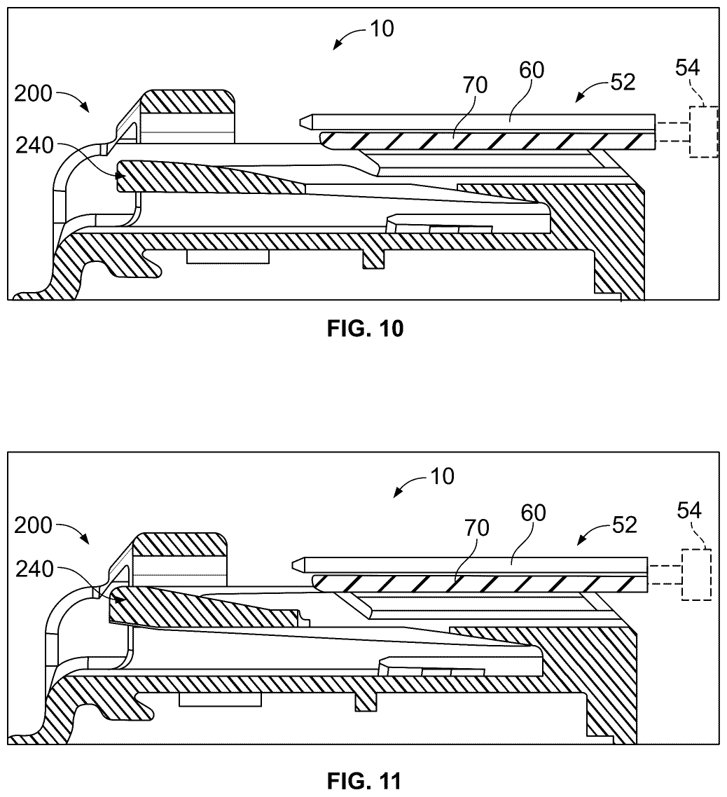

FIG. 10 is a cross sectional view of a portion of the communication system 10 showing the mated verification switch 52 in an open position. FIG. 11 is a cross sectional view of a portion of the communication system 10 showing the mated verification switch 52 in a closed position. The second verification contact 70 is physically separated from the first verification contact 60 in the open position (FIG. 10). The second verification contact 70 engages the first verification contact 60 in the closed position (FIG. 11). When the mated verification circuit 54 is closed, the verification signal is configured to be transmitted through the mated verification switch 52 indicative of the electrical connectors 100, 200 being mated.

The second verification contact 70 is configured to be physically separated from the first verification contact 60 prior to the electrical connectors 100, 200 being fully mated. For example, the mated verification circuit 54 is open when the verification contacts 60, 70 are physically separated or open. The second verification contact 70 is configured to engage the first verification contact 60 when the plug connector 200 is fully mated to the header connector 100, such as when the housings 110, 210 are fully mated and/or when the contacts 150, 250 are fully mated and/or when the latches 140, 240 are fully engaged. In an exemplary embodiment, the plug latch 240 is used to actuate or close the second verification contact 70. For example, the plug latch 240 presses the second verification contact 70 upward to close the mated verification circuit 54 by physically contacting the verification contacts 60, 70. However, in alternative embodiments, other portions of the plug connector 200 may interface with the second verification contact 70 to actuate or move the second verification contact 70. For example, a portion of the housing may engage the second verification contact 70. A protrusion, actuator, tab, and the like extending from the housing may engage the second verification contact 70. A connector position assurance (CPA) component may engage the second verification contact 70. The mated verification circuit 54 sends the verification signal through the mated verification switch 52 indicative of the electrical connectors 100, 200 being mated. A visual or audible indicator may be provided when the verification signal is received indicating to the installer that the electrical connectors 100, 200 are fully mated. In alternative embodiments, such as when the mated verification switch 52 is normally closed, rather than being normally open, the plug latch 240 may be used to separate the verification contacts 60, 70 when fully mated to open the mated verification circuit 54 to indicate the mated status of the electrical connectors 100, 200.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. An electrical connector comprising:
a housing having walls extending between a mating end and a terminating end, the mating end configured to be mated to a mating electrical connector;
contacts held by the housing, each contact extending between a mating end and a terminating end, the mating end of the contact configured to be mated to a mating contact of the mating electrical connector;
a securing element configured to be securely coupled to a mating securing element of the mating electrical connector when the housing is fully mated to the mating electrical connector; and
a mated verification switch coupled to the housing, the mated verification switch including a first verification contact and a second verification contact both coupled to the housing, the second verification contact configured to be physically separated from the first verification contact prior to the housing being fully mated to the mating electrical connector, the second verification contact configured to engage the first verification contact when the housing is fully mated to the mating electrical connector to send a verification signal through the mated verification switch indicative of the electrical connector being mated with the mating electrical connector.

2. The electrical connector of claim 1, wherein the second verification contact is movable between an open position and a closed position, the second verification contact configured to be physically separated from the first verification contact in the open position, the second verification contact configured to engage the first verification contact in the closed position to send the verification signal through the mated verification switch.

3. The electrical connector of claim 2, wherein the mated verification switch forms a mated verification circuit in the closed position to send the verification signal.

4. The electrical connector of claim 1, wherein the second verification contact is configured to be moved into contact with the first verification contact by interference with the mating electrical connector.

5. The electrical connector of claim 1, wherein the walls of the housing define a cavity configured to receive the mating electrical connector, the first verification contact and the second verification contact extending into the cavity to interface with the mating electrical connector.

6. The electrical connector of claim 1, wherein the first verification contact includes a mating portion, the second verification contact including a connecting tab configured to engage the mating portion of the first verification contact to electrically connect the first and second verification contacts to send the verification signal through the mated verification switch.

7. The electrical connector of claim 1, wherein the second verification contact is configured to engage the first verification contact only after the securing element is securely coupled to the mating securing element of the mating electrical connector.

8. The electrical connector of claim 1, wherein the second verification contact is configured to interface with the mating securing element of the mating electrical connector when the mating securing element is securely coupled to the securing element to engage the first verification contact.

9. The electrical connector of claim 1, wherein the first and second verification contacts are stamped and formed contacts.

10. The electrical connector of claim 1, wherein the first and second verification contacts include plated plastic conductors.

11. An electrical connector comprising:
a housing having walls forming a cavity, the housing extending between a mating end and a terminating end, the mating end configured to be mated to a mating electrical connector, the terminating end configured to be mounted to a host circuit board;
contacts held by the housing, each contact extending between a mating end and a terminating end, the mating end of the contact configured to be mated to a mating contact of the mating electrical connector, the terminating end of the contact configured to be terminated to the host circuit board;
a securing element configured to be securely coupled to a mating securing element of the mating electrical connector when the housing is fully mated to the mating electrical connector; and
a mated verification switch coupled to the housing, the mated verification switch including a first verification contact and a second verification contact both coupled to the housing, the second verification contact movable between an open position and a closed position, the second verification contact configured to be physically separated from the first verification contact in the open position, the second verification contact configured to engage the first verification contact in the closed position to send a verification signal through the mated verification switch indicative of the electrical connector being mated with the mating electrical connector;
wherein the second verification contact is configured to interface with the mating securing element of the mating electrical connector when the mating securing element is securely coupled to the securing element to engage the first verification contact.

12. The electrical connector of claim 11, wherein the mated verification switch forms a mated verification circuit in the closed position to send the verification signal.

13. The electrical connector of claim 11, wherein the second verification contact is in the open position prior to the housing being fully mated to the mating electrical connector, the second verification contact engaging the first verification contact when the housing is fully mated to the mating electrical connector to send the verification signal through the mated verification switch.

14. The electrical connector of claim 11, wherein the walls of the housing define a cavity configured to receive the mating electrical connector, the first verification contact and the second verification contact extending into the cavity to interface with the mating electrical connector, the second verification contact being moved to the closed position by interference with the mating electrical connector when the mating electrical connector is fully plugged into the cavity.

15. The electrical connector of claim 11, wherein the first verification contact includes a mating portion, the second verification contact including a connecting tab configured to engage the mating portion of the first verification contact in the closed position to electrically connect the first and second verification contacts to send the verification signal through the mated verification switch.

16. The electrical connector of claim 11, wherein the second verification contact is configured to engage the first verification contact only after the securing element is securely coupled to the mating securing element of the mating electrical connector.

17. A communication system comprising:
a plug connector including a plug housing, plug contacts held by the plug housing, and a plug securing element;
a header connector including a header housing extending between a mating end and a terminating end, the terminating end configured to be coupled to a host circuit board, the header housing including a cavity configured to receive the plug connector, the header connector including header contacts held by the header housing, each header contact extending between a mating end and a terminating end, the mating end of the header contact configured to be mated to the corresponding plug contact, the terminating end of the header contact configured to be terminated to the host circuit board, the header connector including a header securing element configured to be securely coupled to the plug securing element when the plug housing is fully mated to the header housing; and
a mated verification switch coupled to the header housing, the mated verification switch including a first verification contact and a second verification contact both coupled to the header housing, the second verification contact movable between an open position and a closed position, wherein the second verification is moved to the closed position by interference with the plug connector when the plug connector is mated to the header connector, the second verification contact configured to be physically separated from the first verification contact in the open position, the second verification contact configured to engage the first verification contact in the closed position to send a verification signal through the mated verification switch indicative of the plug connector being mated with the header connector.

18. The communication system of claim 17, wherein the second verification contact is in the open position prior to the plug housing being fully mated to the header housing, the second verification contact engaging the first verification contact when the plug housing is fully mated with the header housing to send the verification signal through the mated verification switch.

19. The electrical connector of claim 17, wherein the second verification contact is configured to be moved to the closed position by interference with the plug connector.

20. The electrical connector of claim 17, wherein the second verification contact is configured to be moved to the closed position by interference with the plug securing element of the plug connector, the second verification contact engaging the first verification contact only after the plug securing element is securely coupled to the header securing element.
